(19) United States
(12) Patent Application Publication
(10) Pub. No.: US 2026/0295601 A1
(43) Pub. Date: Oct. 1, 2026

(54) A METHOD FOR CONTROLLING AN ELECTRIC MOTOR OF A CENTRIFUGAL SEPARATOR

(71) Applicant: Alfdex AB, LANDSKRONA (SE)

(72) Inventor: Thomas ANDERSSON AGINGER, SKÄRHOLMEN (SE)

(73) Assignee: Alfdex AB, LANDSKRONA (SE)

(21) Appl. No.: 19/488,941

(22) PCT Filed: May 23, 2024
(86) PCT No.: PCT/EP2024/064220

§ 371 Date: Dec. 1, 2025

(30) Foreign Application Priority Data
Jun. 19, 2023 (EP) 23180096.2

(51) Int. Cl. B04B 9/10; B04B 5/00; B04B 5/12; B04B 9/04

(52) U.S. Cl. CPC B04B 9/10; B04B 5/005; B04B 5/12; B04B 9/04; B04B 2005/125

(57) ABSTRACT

The present invention provides a method for controlling an electric motor of a centrifugal separator for cleaning gas containing contaminants The centrifugal separator is comprising a stationary casing, enclosing a separation space through which a gas flow is permitted, a rotatable member comprising a plurality of separation members arranged in said separation space and being arranged to rotate around an axis of rotation. The electric motor comprises a stator and a rotor and is arranged for rotating said rotatable member. The method comprises a step of controlling the stator to expose the rotor to a first oscillating magnetic field that increases the temperature of the surroundings of the electric motor without rotating the rotor.

### FIELD OF THE INVENTION

The present invention relates to the field of centrifugal separators for cleaning a gas containing liquid contaminants. In particular, the present invention relates to a method for controlling an electric motor of a centrifugal separator for cleaning gas.

### BACKGROUND OF THE INVENTION

It is well known that a mixture of fluids having different densities may be separated from one another through use of a centrifugal separator. One specific use of such a separator is in the separation of oil from gas vented from a crankcase forming part of an internal combustion engine.

With regard to this specific use of separators, there can be a tendency for the high-pressure gas found in the combustion chambers of an internal combustion engine to leak past the associated piston rings and into the crankcase of the engine. This continuous leaking of gas into the crankcase can lead to an undesirable increase of pressure within the crankcase and, as a consequence, to a need to vent gas from the casing. Such gas vented from the crankcase typically carries a quantity of engine oil (as droplets or a fine mist), which is picked up from the reservoir of oil held in the crankcase.

In order to allow vented gas to be introduced into the inlet system without also introducing unwanted oil (particularly into a turbocharging system wherein the efficiency of the compressor can be adversely affected by the presence of oil), it is necessary to clean the vented gas (i.e. to remove the oil carried by the gas) prior to the gas being introduced into the inlet system. This cleaning process may be undertaken by a centrifugal separator, which is mounted on or adjacent the crankcase and which directs cleaned gas to the inlet system and directs separated oil back to the crankcase. An example of such a separator is disclosed e.g. in U.S. Pat. No. 8,657,908.

The rotational motion of such a centrifugal separator may be performed by e.g. an electric motor. However, when the temperature of the oil is low its viscosity increases. Thus, at startup of the centrifugal separator in conditions of low temperature, any oil that has previously been separated from gas but not drained from the separator may adhere to the rotatable portions of the separator, making it harder to start. As an example, oil may be drained down to the motor rotor of the electric motor, making it difficult to start the rotation. There is thus a need in the art for increasing the startup of the centrifugal separator in conditions of low temperature.

### SUMMARY OF THE INVENTION

It is an object of the invention to at least partly overcome one or more limitations of the prior art. In particular, it is an object to provide a method for controlling the electric motor of a centrifugal separator that provides for better startup conditions at lower temperatures.

As a first aspect of the invention, there is provided a method for controlling an electric motor of a centrifugal separator for cleaning gas containing contaminants. The centrifugal separator is comprising
a stationary casing enclosing a separation space through which a gas flow is permitted,
a rotatable member comprising a plurality of separation members arranged in said separation space and being arranged to rotate around an axis (X) of rotation;
wherein said electric motor comprises a stator and a rotor and is arranged for rotating said rotatable member. The method comprises a step of:
controlling the stator to expose the rotor to a first oscillating magnetic field that increases the temperature of the surroundings of the electric motor without rotating the rotor.

The method may be a method of a device, such a s a control unit disclosed herein below. The method is thus a method for controlling the electric motor of a centrifugal separator for cleaning gas. The centrifugal separator may be as disclosed in relation to the second aspect below. The electric motor is thus a part of the centrifugal separator.

The step of controlling the stator may be performed at startup of the centrifugal separator, i.e. when the rotatable member is at standstill. The method thus initiates a heating sequence for heating the surroundings of the electric motor.

The electric motor comprises a stator and a rotor. The stator may comprise windings that produces a rotating magnetic field that drives the rotor upon supply of a current. The rotor thus comprises magnets that follow the rotating magnetic field. The magnets may comprise a ferromagnetic material. The rotor is connected to the rotatable portion of the centrifugal separator, such as attached to a rotatable shaft.

The method may be used with different types of electric motors. The electric motor may be a brushless electric motor. As an example, the electric motor may be a brushless synchronous motor. The motor may be supplied with DC or AC current.

The first aspect of the invention is based on the insight that the hardware of the electric motor used to drive the rotatable portion of the centrifugal separator may also be used as a heating device. During operation of the centrifugal separator, the magnetic field of the stator may drive the rotor at a speed of several thousand rpm, such as between 6000-12000 rpm. However, the inventor has found that if the hardware is used to oscillate the magnetic field in much higher frequencies, such as above 10 kHz, such as about 30 kHz, the rotor does not rotate but is heated instead. This is due to the inductive heating formed, i.e. the magnetic material of the rotor offers resistance to the oscillating magnetic field that produces internal friction and thus heat. This heating of the rotor also heats the surroundings of the electric motor. Thus, any oil present around the rotor will be heated and thus a lowered viscosity so that the subsequent rotation of the rotor is facilitated.

The “surroundings of the electric motor” may be within a motor housing in which some part of the electric motor is present, such as the housing in which the stator and/or a control unit used for controlling the stator is arranged.

The oscillating magnetic field in the step of “controlling the stator to expose the rotor to an oscillating magnetic field so as to increase the temperature of the surroundings of the electric motor without rotating the rotor” may thus have an oscillating frequency high enough so as to increase the temperature of the surroundings of the electric motor without rotating the rotor.

The step of “controlling the stator to expose the rotor to a first oscillating magnetic field that increases the temperature of the surroundings of the electric motor without rotating the rotor” may also refer to “the heating sequence” herein.

The method may be seen as a method of operating a centrifugal separator. Thus, as a configuration of the first aspect of the invention, there is provided a method of operating a centrifugal separator for cleaning gas containing contaminants; said separator comprising
a stationary casing, enclosing a separation space through which a gas flow is permitted,
a rotatable member comprising a plurality of separation members arranged in said separation space and being arranged to rotate around an axis (X) of rotation;
an electric motor arranged for rotating said rotatable member and comprising a stator and a rotor;
wherein the method comprises subjecting the rotor to a first oscillating magnetic field from the stator that increases the temperature of the surroundings of the electric motor without rotating the rotor.

In embodiments of the first aspect, the method additionally comprises the steps of:
determining the temperature of the surroundings of the electric motor; and
determining if the temperature is below a threshold value and if so, performing the step of controlling the stator to expose the rotor to a first oscillating magnetic field that increases the temperature of the surroundings of the electric motor without rotating the rotor.

As an example, the method may additionally comprise the steps of
determining the temperature of the surroundings of the electric motor; and
determining if the temperature is above a threshold value and if so, controlling the stator to rotate the rotor.

Consequently, the heating sequence may be performed only if a measured temperature is below a certain threshold. The method may thus be used when performing a heating sequence in cold weather conditions.

As discussed above, the “surroundings of the electric motor” may be within a motor housing in which some part of the electric motor is present, such as the housing in which the stator and/or a control unit used for controlling the stator is arranged. However, the surroundings of the electric motor in which the temperature is determined may also be a volume outside of the centrifugal separator, such as at the inlet or any outlet of the separator or at a position of the engine to which the separator is mounted.

In embodiments of the first aspect, the method additionally comprises the steps of:
determining the rotational speed of the rotor; and
determining if the rotational speed is below a threshold value and if so, performing the step of controlling the stator to expose the rotor to a first oscillating magnetic field that increases the temperature of the surroundings of the electric motor without rotating the rotor.

As an example, the method may additionally comprise the steps of
determining rotational speed of the rotor; and
determining if the rotational speed is above a threshold value and if so, controlling the stator to rotate the rotor.

Consequently, also the rotational speed of the rotor may be used for initiating the heating sequence. Measuring a rotational speed that is a below a threshold value may thus indicate that the rotor is experiencing some resistance due to e.g. residual oil that needs to be heated in order for a better performance.

The heating sequence may in embodiments be initiated based on information from both the measured temperature and the measured rotational speed.

Thus, as an example, the method may comprise the additional steps of
determining the temperature of the surroundings of the electric motor and the rotational speed of the rotor, and
determining if the temperature is below a first threshold value and determining if the rotational speed of the rotor is below a second threshold value, and if so,
performing the step of controlling the stator to expose the rotor to a first oscillating magnetic field that increases the temperature of the surroundings of the electric motor without rotating the rotor.

In embodiments of the first aspect, the first oscillating magnetic field has a frequency of above 5 kHz, such as above 15 kHz.

As an example, the first oscillating magnetic field may have a frequency of between 20-60 kHz, such as between 25-50 KHz. Such frequencies may be suitable for generating enough heat in the rotor via induction. As an example, the oscillating magnetic field may have a frequency of about 30 KHz.

In embodiments of the first aspect, the method is further comprising the step of controlling the stator to expose the rotor to a second oscillating magnetic field that rotates the rotor. The second oscillating magnetic field may oscillate at a frequency other than the first frequency. The second frequency may be within the normal operational frequency used for rotating the rotor. Thus, the second oscillating magnetic field may be the oscillating magnetic field used to drive the rotor and thus the centrifugal separator. The second oscillating magnetic field may give rise to a rotational speed of the rotor that is in the range of 6.000-14.000 rpm.

As an example, the method may comprise controlling the stator to expose the rotor to the first and second oscillating magnetic field simultaneously. Thus, the first and second oscillating magnetic field may be superimposed on each other, meaning that driving the rotor and performing the heating sequence may be performed at the same time.

In embodiments of the first aspect the step of controlling the stator to expose the rotor to a first oscillating magnetic field that increases the temperature of the surroundings of the electric motor without rotating the rotor continues for at least 30 s.

As an example, the step of controlling may continue for e.g. 30-60 s. Such a time interval may be sufficient to heat any oil adjacent to the rotor of the electric motor.

As a second aspect of the invention, there is provided a centrifugal separator for cleaning gas containing contaminants. The centrifugal separator comprises
a stationary casing, enclosing a separation space through which a gas flow is permitted,
a rotatable member comprising a plurality of separation members arranged in said separation space and being arranged to rotate around an axis (X) of rotation;
an electric motor comprising a stator and a rotor and is arranged for rotating said rotatable member; and
a control unit that is operative to control the stator to expose the rotor to a first oscillating magnetic field that increases the temperature of the surroundings of the electric motor without rotating the rotor.

As used herein, the term “axially” denotes a direction which is parallel to the rotational axis (X). Accordingly, relative terms such as “above”, “upper”, “top”, “below”, “lower”, and “bottom” refer to relative positions along the rotational axis (X). Correspondingly, the term “radially” denotes a direction extending radially from the rotational axis (X). A “radially inner position” thus refers to a position closer to the rotational axis (X) compared to “a radially outer position”.

An axial plane refers to a plane having a normal extending perpendicular to the axis of rotation (X). A radial plane refers to a plane having a normal extending parallel to the axis of rotation (X).

The control unit may comprise a processing unit and a storage medium, said storage medium containing instructions executable by the processing unit. The processing unit may thus be arranged to cause the control unit to carry out the method according to the first aspect when the appropriate computer program comprising computer-executable instructions is downloaded to the storage medium and executed by the processing unit.

The control unit is thus arranged for activating and controlling the speed and operation of the electric motor.

The control unit may further comprise a circuit board. The circuit board may comprise the above-mentioned processing unit and storage medium.

The second aspect may generally present the same or corresponding advantages as the first aspect. Effects and features of the second aspect are largely analogous to those described above in connection with the first aspect. Embodiments mentioned in relation to the first aspect are largely compatible with the second aspect.

Thus, the centrifugal separator according to the second aspect may be operative to perfume the heating sequence of the rotor, so that any oil adhered to the rotor is heated. This facilitates subsequent startup of the centrifugal separator e.g. in cold weather conditions.

In embodiments of the second aspect, the centrifugal separator is free of any further heating device dedicated for heating the surroundings of the electric motor.

In embodiments of the second aspect, the control unit is further operative to:
acquire temperature data of the surroundings of the electric motor; and
determine, based on the acquired temperature, if the temperature is below a threshold value and if so,
control the stator to expose the rotor to a first oscillating magnetic field that increases the temperature of the surroundings of the electric motor without rotating the rotor.

As discussed above, the “surroundings of the electric motor” may be within a motor housing in which some part of the electric motor is present, such as the housing in which the stator and/or a control unit used for controlling the stator is arranged. However, the surroundings of the electric motor in which the temperature is determined may also be a volume outside of the centrifugal separator, such as at the inlet or any outlet of the separator or at a position of the engine to which the separator is mounted.

The centrifugal separator may therefore further comprise a temperature sensor arranged for measuring the temperature of the surroundings of the electric motor, and wherein the control unit is operative to acquire temperature data from said temperature sensor.

As an example, the control unit may comprise a circuit board and the temperature sensor may be arranged on the circuit board.

The centrifugal separator may comprise a motor housing in which the electric motor, or at least the stator of the electric motor, is enclosed. Also the control unit may be arranged in the motor housing.

In embodiments of the second aspect, the control unit is further operative to:
determine if the acquired temperature above a threshold value and if so, controlling the stator to rotate the rotor.

The control unit may thus be configured to initiate the heating sequence before start, i.e. before rotation of the rotatable member of the centrifugal separator, based on measured temperature data. If the temperature is below a threshold value, the heating sequence may be initiated, and if the measured temperature is above the threshold value, it may instead initiate the start of the centrifugal separator.

In embodiments of the second aspect, the control unit is further operative to:
acquire rotational speed data from the rotor; and
determine, based on the acquired rotational speed data, if the rotational speed is below a threshold value and if so,
control the stator to expose the rotor to a first oscillating magnetic field that increases the temperature of the surroundings of the electric motor without rotating the rotor.

Thus, as discussed in relation to the first aspect above, the heating sequence may be initiated based on acquired rotational speed data from the rotor.

Further, the control unit may further be operative to:
determine if the rotational speed above a threshold value and if so, controlling the stator to rotate the rotor.

In embodiments of the second aspect, the first oscillating magnetic field has a frequency of above 5 kHz, such as above 15 kHz. As an example, the first oscillating magnetic field may have a frequency of between 20-60 kHz, such as between 25-50 KHz. Such frequencies may be suitable for generating enough heat in the rotor via induction. As an example, the first oscillating magnetic field may have a frequency of about 30 KHz.

In embodiments of the second aspect, the control unit is operative to control the stator to expose the rotor to a first oscillating magnetic field for at least 30 s.

In embodiments of the second aspect, the control unit is further operative to control the stator to expose the rotor to a second oscillating magnetic field that rotates the rotor. The control unit may be operative to control the stator to expose the rotor to the first and second oscillating fields simultaneously.

The electric motor may be arranged axially above or below the separation space. Thus, in embodiments of the second aspect, the electric motor is arranged axially below the separation space.

The centrifugal separator is arranged for cleaning gas containing contaminants. The contaminants in the gas may comprise liquid contaminants, such as oil, and soot. Consequently, the centrifugal separator may be for separating liquid contaminants, such as oil, from gas. The gas may be crankcase gas of a combustion engine. However, the centrifugal separator may also be suitable for cleaning gases from other sources, for instance the environment of machine tools which frequently contains large amounts of liquid contaminants in the form of oil droplets or oil mist.

Furthermore, the centrifugal separator may comprise
a gas inlet extending through the stationary casing and permitting supply of the gas to be cleaned,
a gas outlet arranged in the stationary casing and configured to permit discharge of cleaned gas and comprising an outlet opening through a wall of the stationary casing, and
a drainage outlet configured to permit discharge of liquid contaminants separated from the gas to be cleaned;

The stationary casing of the centrifugal separator may comprise a surrounding side wall, and first and second end walls, which enclose the separation space. The stationary casing may have a cylindrical shape with circular cross-section having a radius R from the axis (X) of rotation to the surrounding side wall. This radius R may be constant at least with respect to a major part of the circumference of the surrounding side wall. The first and second end walls may thus form an upper end wall and a lower end wall of the cylindrical shaped casing. The stationary casing may also be slightly conical.

The gas inlet of the centrifugal separator may be arranged through the first end wall or through the surrounding side wall close to the first end wall, thus at the top of the separator, such that gas entering through the gas inlet is directed to the separation space. The downstream portion of the gas inlet may be centred around the axis of rotation (X). The gas inlet may further comprise upstream portion in the form of an inlet conduit. This conduit may extend radially or axially from the centrifugal separator.

The drainage outlet is usually arranged in the lower portion of the stationary casing, such as arranged in the second end wall. Thus, the drainage outlet may be arranged centrally in an end wall opposite the end wall through which, or at which, the inlet is arranged. The drainage outlet of the centrifugal separator may further be formed by several spot shaped through holes of the stationary casing or by a single drainage passage. The drainage outlet may be arranged at the axis of rotation or centred around the axis of rotation. The drainage outlet may also be in an annular collection groove at the inner end wall of the stationary casing.

The gas outlet may be in the form of a gas conduit in through a wall of the stationary casing, such as in a lower portion of the surrounding side wall of the stationary casing. However, the gas outlet may also be arranged an upper portion of the stationary casing.

The rotatable member is arranged for rotation during operation by means of the electric motor. The separation members of the rotatable member are examples of surface-enlarging inserts that promote separation of contaminants from the gas.

In embodiments of the first aspect, the plurality of separation members is a stack of separation discs.

The separation discs of the stack may be frustoconical. A frustoconical disc may have a planar portion extending in a plane that is perpendicular to the axis of rotation, and a frustoconical portion that may extend upwards or downwards. The planar portion may be closer to the rotational axis than the frustoconical portion.

Further, the discs of the stack may be radial discs, in which substantially the whole disc extends in a plane that is perpendicular to the axis of rotation.

It is also to be understood that the separation members, such as separation discs, not necessarily have to be arranged in a stack. The separation space may for example comprise axial discs, or plates that extend around the axis of rotation. The axial discs or plates may be planar, i.e. extending in planes that are parallel to the axis of rotation. The axial discs or plates may also have a slightly or significantly curved shape, such as an arcuate or spiral shape, as seen in a radial plane.

The rotatable member is journaled within the stationary casing by at least one bearing, such as by at least two bearings. Each of the bearings may be retained in an individual bearing holder.

During operation, gas to be cleaned may be directed centrally through the plurality of separation members, such as centrally through the stack of separation discs. In such a set-up, the rotatable member may further define a central space formed by at least one through hole in each of the separation members. This central space is connected to the gas inlet and configured to convey the gas to be cleaned from the gas inlet to the interspaces between the separation members, such as between the interspaces between the discs of a stack of separation discs. A separation disc that may be used as separation member may comprise a central, essentially flat portion perpendicular to the axis of rotation. This portion may comprise the through holes that form parts of the central space.

Thus, the centrifugal separator may be configured to lead gas to be cleaned, such as crankcase gases, from the gas inlet into a central portion of the rotatable member. In this manner the crankcase gases may be “pumped” from the central portion of the rotatable member into the interspaces between the separation discs in the stack of separation discs by the rotation of the rotatable member. Thus, the centrifugal separator may work according to the concurrent flow principle, in which the gas flows in the disc stack from a radial inner part to a radial outer part, which is opposite to a separator operating according to the counter-current flow principle, in which the gas is conducted into the centrifugal rotor at the periphery of the rotor and is led towards a central part of the rotor.

As a third aspect of the invention, there is provided a computer program comprising computer-executable instructions for causing a centrifugal separator according to the second aspect to perform steps recited in the first aspect when the computer-executable instructions are executed on a processing unit included in the control unit of the centrifugal separator.

As third aspect of the invention, there is provided a computer readable medium having stored thereon the computer program of the third aspect of the invention.

The third and fourth aspects may generally present the same or corresponding advantages as the first and second aspects. Effects and features of these aspects are largely analogous to those described above in connection with the first and second aspects. Embodiments mentioned in relation to the first and second aspect are largely compatible with the third and fourth aspect.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of the cross-section of an embodiment of a centrifugal separator for cleaning gas.

FIG. 2 schematically illustrates an embodiment of the method of controlling an electric motor of a centrifugal separator.

FIG. 3 schematically illustrates an embodiment of the method of controlling an electric motor of a centrifugal separator.

FIG. 4 shows a schematic drawing of the control unit of the centrifugal separator.

### DETAILED DESCRIPTION

The different aspects of the present disclosure will be further illustrated by the following description with reference to the accompanying drawings.

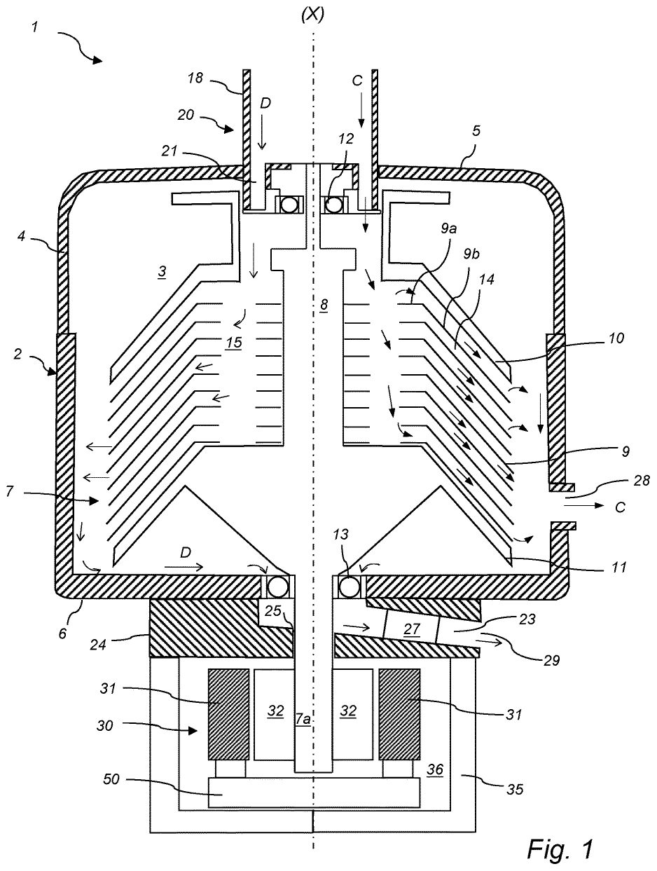

FIG. 1 shows a cross-section of a centrifugal separator 1 according to the present disclosure. The centrifugal separator 1 comprises a stationary casing 2, which is configured to be mounted to a combustion engine (not disclosed), especially a diesel engine, at a suitable position, such as on top of the combustion engine or at the side of the combustion engine.

It is to be noted that the centrifugal separator 1 is also suitable for cleaning gases from other sources than combustion engines, for instance the environment of machine tools which frequently contains large amounts of liquid contaminants in the form of oil droplets or oil mist.

The stationary casing 2 encloses a separation space 3 through which a gas flow is permitted. The stationary casing 2 comprises, or is formed by, a surrounding side wall 4, an upper end wall 5 and a lower end wall 6.

The centrifugal separator further comprises a rotatable member 7, which is arranged to rotate around an axis (X) of rotation relative the stationary casing 2.

The stationary casing 2 has a radius from the axis (X) of rotation to the surrounding side wall 4 that is constant at least with respect to a major part of the circumference of the surrounding side wall 4. The surrounding side wall 4 thus has a circular, or substantially, circular cross-section.

The rotatable member 7 comprises a rotatable shaft, i.e. spindle 8 and separation members in the form of a stack of separation discs 9 attached to the spindle 8 and arranged in the separation space 3. All the separation discs of the stack 9 are provided between a top disc 10 and a lower end plate 11. The spindle 8, and thus the rotatable member 7, is rotatably supported in the stationary casing 2 by means of an upper bearing 12 and a lower bearing 13, the bearings being arranged one on each axial side of the stack of separation discs 9.

The separation discs of the disc stack 9 are frusto-conical and extend outwardly and downwardly from the spindle 8. The separation discs thus comprise an inner flat portion 9a, which extend perpendicularly to the axis of rotation (X), and a conical portion 9b, that extend outwardly and downwardly from the flat portion 9a. It should be noted that the separation discs also could extend outwardly and upwardly, or even radially.

The separation discs of the stack 9 are provided at a distance from each other by means of distance members (not disclosed) in order to form interspaces 14 between adjacent separation discs 9, i.e. an interspace 14 between each pair of adjacent separation discs 9. The axial thickness of each interspace 14 may e.g. be in the order of 0.5-2 mm, such as 1-2 mm.

The separation discs of the stack 9 may be made of plastic or metal. The number of separation discs in the stack 9 is normally higher than indicated in FIG. 1 and may be for instance 50 to 100 separation discs 9 depending on the size of the centrifugal separator.

The rotatable member 7 further defines a central space 15. The central space 15 is formed by a through hole in each of the separation discs 9. In the embodiments of FIG. 1, the central space 15 is formed by a plurality of through holes, each extending through the top disc 10 and through each of the separation discs 9, but not through the lower end plate 11. The through holes are arranged in the flat portions 9a of the separation discs.

The gas inlet 20 is for the supply of the gas to be cleaned. The gas inlet 20 extends through the stationary casing 2, and more precisely through upper end wall 5. The gas inlet 20 is formed by the axially extending inlet conduit 18 and through channels 21, which are arranged radially outside the upper bearing 12 and through which the inlet conduit 18 communicates with central space 15.

The gas inlet 20 communicates with the central space 15 so that the gas to be cleaned is conveyed from the inlet 20 via the central space 15 to the interspaces 14 of the stack of separation discs 9. The gas inlet 20 is thus configured to communicate with the crankcase of the combustion engine, or any other source, via the inlet conduit 18, thereby permitting the supply of crankcase gas from the crankcase to the centrifugal separator 1.

The gas outlet 28 of the centrifugal separator 1 is in this example arranged in the lower portion of the stationary casing 2 and is configured to permit discharge of cleaned gas. The gas outlet 28 comprises an outlet conduit through the surrounding side wall 4 of the stationary casing 2. However, the gas outlet 28 could also be arranged in an upper portion of the stationary casing 2, such as in the upper end wall 5.

Axially below lower end wall 6 of the stationary casing 2 is a housing 24 for the drainage of separated contaminants, such as oil. This housing 24 comprises a liquid outlet chamber or passage 23. This passage 23 extends from a central portion of the separator below the lower bearing 13 to the drainage outlet 29 to permit discharge of liquid contaminants separated from the gas. Thus, separated oil may be drained through the lower bearing 13 to the passage 23, or via through holes (not shown) in the lower end wall 6 near the lower bearing to the passage 23. There is also a check valve 27 arranged in the passage 23. The check valve 27 prevents flow of fluid into the passage 23 via the drainage outlet 29. The check valve 7 comprises an umbrella valve, as disclosed in EP3103554.

Axially below the housing 24, and thus axially below the separation space 3 and the stationary casing 2, is a motor housing 35 arranged. In this motor housing 35 is the electric motor 30 arranged. The electric motor 30 comprises a rotor 32 that is connected to drive shaft 7a, which in turn is a part of the rotatable member 7. The stator 31 of the electric motor is at least partially surrounding the rotor 32. The stator comprises a stator iron core and windings for producing a magnetic field affecting the magnets of the rotor 32. There is also a power connector (not shown) for feeding electric current to the electric motor 30.

Also arranged in the motor housing 35 is a control unit 50 operative to control the stator to expose the rotor to a magnetic field to thereby rotate the rotor and the rotatable member 7. The control unit 50 is configured or operative to send control signals to vary for example the voltage or current that is fed to the stator 31.

The control unit 50 may also comprise a temperature sensor 55 for measuring the temperature of the surroundings of the electric motor.

The control unit will further be discussed in relation to FIG. 3 below.

During operation of the centrifugal separator as shown in FIG. 1, the rotatable member 7 is kept in rotation electric motor 30. As an example, the rotational speed may be in the range of 6.000-14.000 rpm, such as between 7.500-12.000 rpm. Contaminated gas, e.g. crankcase gas from the crankcase of an internal combustion engine, is supplied to the gas inlet 20 via conduit 18. This gas is conducted further into the central space 15 and from there into and through the interspaces 14 between the separation discs of the stack 9. As a consequence of the rotation of the rotatable member 7, the gas is brought to rotate, whereby it is pumped further on, radially and outwardly, through the gaps or interspaces 14. During the rotation of the gas in the interspaces 14, solid or liquid particles such as oil suspended in the gas are separated therefrom. The particles settle on the insides of the conical portions 9b of the separation discs and slide after that radially outwardly thereon. When the particles and/or liquid drops have reached out to the radial outer edges of the separation discs 9, they are thrown away from the rotatable member 7 to hit the inner surface of the surrounding side wall 4. Separated oil particles may form a film on the inner surface of the stationary casing 2. From there, oil may be pulled by gravity downwardly to bottom end wall 6 and then and leave the separation space 3 through the lower bearing 13 or via through holes of the lower end wall 6 near the bearing 13. The path of the contaminants in the gas is schematically illustrated by arrows “D” in FIG. 1. Cleaned gas freed from particles and exiting from the stack of separation discs 9 leaves the stationary casing 2 through the gas outlet 28. The path of the gas through the centrifugal separator 1 is schematically shown by arrows “C” in FIG. 1.

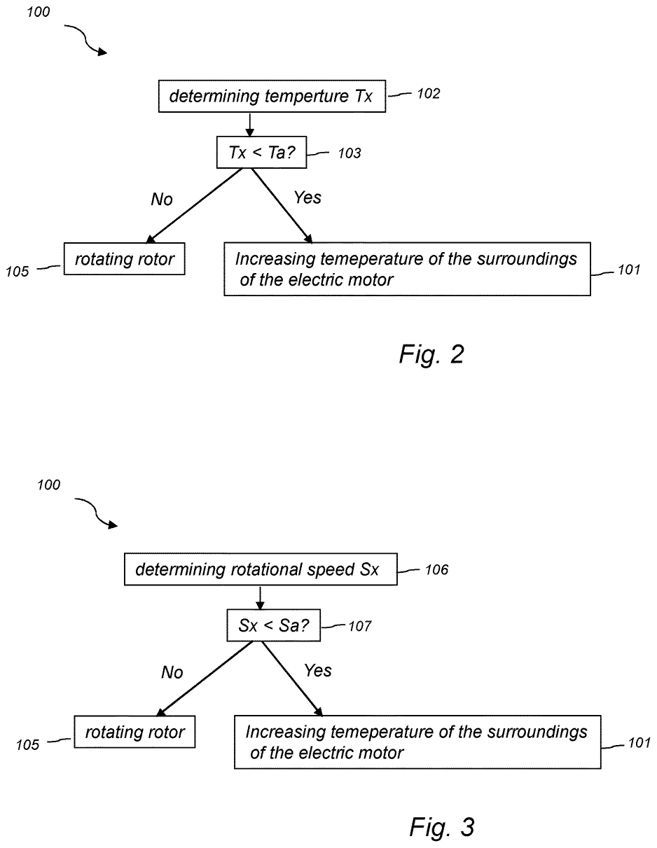

Before startup, a heating sequence according to the method of the present invention may be performed to heat any residual oil that may be present at the rotor 32. As an example, oil drained in passage 23 may flow via the small interspace 25 between the rotor shaft 7a and the inner wall of the housing 24 down to the rotor. At cold conditions, such oil has a high viscosity making the electric motor difficult to start. Thus, in order to facilitate start at cold conditions, the heating sequence may be performed. This method 100 is discussed in relation to FIG. 2 below. The method 100 may be performed by the control unit 50.

FIG. 2 shows a flowchart illustrating the method 100 for controlling an electric motor 30 of a centrifugal separator 1 according to an embodiment. The centrifugal separator 1 may thus be a centrifugal separator as discussed in relation to FIG. 1 above.

The method 100 comprises a step of determining 102 the temperature Tₓ of the surroundings of the electric motor 30. The surroundings may for example be the inner space 36 that is enclosed by the motor housing 35. The temperature may be measured using a temperature sensor 55, such as a temperature sensor within the control unit 50.

The method further comprises a step of determining 103 if the temperature Tₓ is below a threshold value Tₐ. If so, the method comprises a step of initiating a heating sequence, which is performing the step of controlling 101 the stator 31 to expose the rotor 32 to a first oscillating magnetic field so as to increase the temperature of the surroundings of the electric motor 31 without rotating the rotor 32. This step of controlling may comprise controlling the stator 31 to expose the rotor 32 of high frequency, such as a frequency of between 20-60 kHz, such as about 60 kHz. At such high frequency, the rotor 32 will not rotate but instead be heated due to induction heating. The heating sequence may be performed for at least 15 s, such as at least 30 s. Thus, the step of controlling 101 the stator 31 to expose the rotor 32 to a first oscillating magnetic field so as to increase the temperature of the surroundings of the electric motor 31 without rotating the rotor 32 may continue for at least 15 s, such as at least 30 s.

Further, if the determined temperature Tₓ of the surroundings of the electric motor 30 is above the threshold Tₐ, normal operation and rotation of the rotor 32 may be initiated. Thus, the method may comprise a step of determining 102 the temperature Tₓ of the surroundings of the electric motor 30 and determining 104 if the temperature is above a threshold value Tₐ and if so, controlling 105 the stator 31 to rotate the rotor 32. The rotation of the rotor may be at a speed of several thousands of rpm, such as in the range of 6.000-14.000 rpm.

As discussed herein, the heating sequence of the present invention may also be initiated based on measurement s on the rotational speed. FIG. 3 shows a flowchart illustrating the method 100 for controlling an electric motor 30 of a centrifugal separator 1 according to such an embodiment. The centrifugal separator 1 may thus be a centrifugal separator as discussed in relation to FIG. 1 above.

The method 100 comprises a step of determining 106 the rotational speed Sₓ of the rotor 32. The rotational speed may for example be determined using a speed sensor (not shown).

The method 100 further comprises a step of determining 107 if the rotational speed Sₓ is below a threshold value Sₐ. If so, the method comprises a step of initiating a heating sequence, which is performing the step of controlling 101 the stator 31 to expose the rotor 32 to a first oscillating magnetic field so as to increase the temperature of the surroundings of the electric motor 31 without rotating the rotor 32. This step of controlling may comprise controlling the stator 31 to expose the rotor 32 of high frequency, such as a frequency of between 20-60 kHz, such as about 60 kHz. At such high frequency, the rotor 32 will not rotate but instead be heated due to induction heating. The heating sequence may be performed for at least 15 s, such as at least 30 s. Thus, the step of controlling 101 the stator 31 to expose the rotor 32 to a first oscillating magnetic field so as to increase the temperature of the surroundings of the electric motor 31 without rotating the rotor 32 may continue for at least 15 s, such as at least 30 s.

Further, if the determined rotational speed Sₓ of the rotor above the threshold Sₐ, normal operation and rotation of the rotor 32 may be initiated. Thus, the method 100 may comprise a step of determining 106 the rotational speed Sₓ of the rotor 32 and determining 107 if the rotational speed is above a threshold value Sₐ and if so, controlling 105 the stator 31 to rotate the rotor 32. The rotation of the rotor may be at a speed of several thousands of rpm, such as in the range of 6.000-14.000 rpm.

In the method 100 discussed in relation to FIGS. 2 and 3, there may also be a simultaneous step of controlling 101 the stator 31 to expose the rotor 32 to a second oscillating magnetic field that rotates the rotor 32. The second oscillating magnetic field may oscillate at a frequency other than the first frequency. The second frequency may be within the normal operational frequency used for rotating the rotor. This may be performed at the same time as performing the heating sequence, i.e. exposing the rotor 32 to the first oscillating magnetic field.

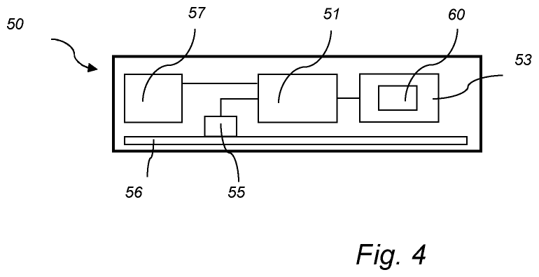

FIG. 4 illustrates a control unit 50 configured to control an electric motor 30 of a centrifugal separator 1 for cleaning gas containing contaminant according to an embodiment, where the steps of the method 100 performed by the control unit 50 in practice are performed by a processing unit 51. This processing unit 51 is embodied in the form of one or more microprocessors arranged to execute a computer program 60 downloaded to a storage medium 53 associated with the microprocessor, such as a Random Access Memory (RAM), a Flash memory or a hard disk drive.

The processing unit 51 is arranged to cause the control unit 50 to carry out the method according to embodiments when the appropriate computer program 60 comprising computer-executable instructions is downloaded to the storage medium 53 and executed by the processing unit 51. The storage medium 53 may also be a computer program product comprising the computer program 60. As an example, the computer program 60 may be transferred to the storage medium 53 by means of a suitable computer program product or downloaded to the storage medium 53 over a network. The processing unit 51 may alternatively be embodied in the form of a digital signal processor (DSP), an application specific integrated circuit (ASIC), a field-programmable gate array (FPGA), a complex programmable logic device (CPLD), etc.

The control unit 50 further comprises a communication interface 57 (wired and/or wireless) over which the device 50 is configured to transmit and receive data. The communication interface 57 may also be used to send operable instructions to control the stator 31 to expose the rotor 32 to an oscillating magnetic field.

Further, in this embodiment, the control unit 50 comprises a circuit board, such as a printed-circuit board (PCB). On this circuit board a temperature sensor 55 is arranged. Also, one or several of the processing unit 51, the storage medium 53 and the communication interface 57 may be arranged on the circuit board 56.

The temperature measured by the temperature sensor 55 may be the temperature of the surroundings of the electric motor 30, such as the temperature within the motor housing 35. The processing unit 50 is configured to receive information from the temperature sensor 55, i.e. operative to acquire temperature data from said temperature sensor 55 and, determine, based on the acquired temperature, if the acquired temperature is below or above a threshold value. If the temperature is below the threshold value, the heating sequence comprising the step 101 of controlling the stator 31 to expose the rotor 32 to a first oscillating magnetic field so as to increase the temperature of the surroundings of the electric motor 30 without rotating the rotor 32, may be initiated. As discussed above, the first oscillating magnetic field may have a frequency of above 5 kHz, such as above 15 kHz, in order to induce heat in the rotor 32. As an example, the control unit 50 may be operative to control the stator 31 to expose the rotor 32 to a first oscillating magnetic field for at least 30 s.

Consequently, the control unit 50 is operative to acquire temperature data of the surroundings of the electric motor 30; and determine, based on the acquired temperature, if the temperature is below a threshold value and if so, control the stator 31 to expose the rotor 32 to an oscillating magnetic field so as to increase the temperature of the surroundings of the electric motor (30) without rotating the rotor 32.

The control unit 50 is further operative to determine if the acquired temperature above a threshold value and if so, controlling the stator 31 to rotate the rotor 32.

As discussed above, the heating sequence may also be initiated based on measured rotational speed data.

Consequently, as an alternative or complement, the control unit is operative to acquire rotational speed data from the rotor 32 and determine, based on the acquired rotational speed data, if the rotational speed is below a threshold value. If so, the control unit 50 may be operative to control the stator 31 to expose the rotor 32 to a first oscillating magnetic field that increases the temperature of the surroundings of the electric motor 30 without rotating the rotor 32. The control unit 50 may further be operative to determine if the rotational speed above a threshold value and if so, controlling the stator 31 to rotate the rotor 32.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A method for controlling an electric-motor of a centrifugal separator for cleaning gas containing contaminants; said centrifugal separator comprising
a stationary casing, enclosing a separation space through which a gas flow is permitted; and
a rotatable member comprising a plurality of separation members arranged in said separation space and being arranged to rotate around an axis of rotation,
wherein said electric motor comprises a stator and a rotor and is arranged for rotating said rotatable member; and
wherein the method comprises:
controlling the stator to expose the rotor to a first oscillating magnetic field that increases a temperature of a surroundings of the electric motor without rotating the rotor.

2. The method according to claim 1, further comprising:
determining the temperature of the surroundings of the electric motor; and
determining if the temperature is below a threshold value and if so, performing the step of controlling the stator to expose the rotor to a first oscillating magnetic field that increases the temperature of the surroundings of the electric motor without rotating the rotor.

3. The method according to claim 2, further comprising:
determining the temperature of the surroundings of the electric motor; and
determining if the temperature is above a threshold value and if so, controlling the stator to rotate the rotor.

4. The method according to claim 1, further comprising:
determining a rotational speed of the rotor; and
determining if the rotational speed is below a threshold value and if so, performing the controlling the stator to expose the rotor to a first oscillating magnetic field that increases the temperature of the surroundings of the electric motor without rotating the rotor.

5. The method according to claim 4, further comprising:
determining if the rotational speed is above a threshold value and if so, controlling the stator to rotate the rotor.

6. The method according to claim 1, wherein the first oscillating magnetic field has a frequency of above 5 kHz, including above 15 kHz.

7. The method according claim 1, further comprising controlling the stator to expose the rotor to a second oscillating magnetic field that rotates the rotor.

8. The method of claim 1, wherein the controlling the stator to expose the rotor to a first oscillating magnetic field that increases the temperature of the surroundings of the electric motor without rotating the rotor continues for at least 30 s.

9. A centrifugal separator for cleaning gas containing contaminants; said centrifugal separator comprising
a stationary casing, enclosing a separation space through which a gas flow is permitted;
a rotatable member comprising a plurality of separation members arranged in said separation space and being arranged to rotate around an axis of rotation;
an electric motor comprising stator and rotor and is arranged for rotating said rotatable member; and
a control unit that is operative to control the stator to expose the rotor to a first oscillating magnetic field that increases a temperature of a surroundings of the electric motor without rotating the rotor.

10. The centrifugal separator according to claim 9, wherein the control unit is further operative to:
acquire temperature data of the surroundings of the electric motor;
determine, based on the acquired temperature data, if a temperature is below a threshold value and if so,
control the stator to expose the rotor to a first oscillating magnetic field that increases the temperature of the surroundings of the electric motor without rotating the rotor.

11. The centrifugal separator according to claim 9, wherein the control unit is further operative to:
acquire rotational speed data from the rotor;
determine, based on the acquired rotational speed data, if a rotational speed is below a threshold value and if so,
control the stator to expose the rotor to a first oscillating magnetic field that increases the temperature of the surroundings of the electric motor without rotating the rotor.

12. The centrifugal-separator separator according to claim 11, wherein the control unit is further operative to:
determine if the rotational speed above a threshold value and if so, controlling the stator to rotate the rotor.

13. The centrifugal separator according to claim 9, wherein the first oscillating magnetic field has a frequency of above 5 kHz, such as above 15 kHz.

14. A computer program comprising computer-executable instructions for causing a centrifugal separator according to claim 9 to perform steps recited in claim 9 when the computer-executable instructions are executed on a processing unit included in the control unit of the centrifugal separator.

15. A computer readable medium, having stored thereon the computer program of claim 14.

16. The method according to claim 2, further comprising:
determining a rotational speed of the rotor; and
determining if the rotational speed is below a threshold value and if so, performing the controlling the stator to expose the rotor to a first oscillating magnetic field that increases the temperature of the surroundings of the electric motor without rotating the rotor.

17. The method according to claim 3, further comprising:
determining a rotational speed of the rotor; and
determining if the rotational speed is below a threshold value and if so, performing the controlling the stator to expose the rotor to a first oscillating magnetic field that increases the temperature of the surroundings of the electric motor without rotating the rotor.

18. The method according to claim 2, wherein the first oscillating magnetic field has a frequency of above 5 kHz.

19. The method according to claim 3, wherein the first oscillating magnetic field has a frequency of above 5 kHz.

20. The method according to claim 4, wherein the first oscillating magnetic field has a frequency of above 5 kHz.
